(19) United States
(12) Patent Application Publication
(10) Pub. No.: US 2018/0243936 A1
(43) Pub. Date: Aug. 30, 2018

(54) Process for Preparing a Flame Retardant and/or Strengthened Fiberboard

(71) Applicant: Cefla Deutschland GmbH, Meckenheim (DE)

(72) Inventor: Gerhard Stahl, Bad Neuenahr-Ahrweiler (DE)

(21) Appl. No.: 15/903,130

(22) Filed: Feb. 23, 2018

(30) Foreign Application Priority Data
Feb. 24, 2017 (DE) 10 2017 203 086.0

(51) Int. Cl. B27K 3/08; B27K 3/02

(52) U.S. Cl. CPC B27K 3/08; B27K 3/0285; B27K 2240/30; B27K 3/0228; B27K 2200/10; B27K 3/025

(57) ABSTRACT

In a process for the production of a flame retardant and/or strengthened fiberboard, a tailored fiberboard is charged on a processing device at first. Subsequently, a flame retardant and/or strengthening agent is applied to the top side of the fiberboard. The agent applied is sucked or pressed into the fiberboard. This is achieved by generating a pressure difference between the top side and bottom side of the fiberboard.

### CROSS-REFERENCE TO RELATED APPLICATION

This application claims priority to German Patent Application No. 10 2017 203 086.0 filed Feb. 24, 2017, the disclosure of which is hereby incorporated in its entirety by reference.

### BACKGROUND OF THE INVENTION

### Field of the Invention

The invention relates to a process for preparing a flame retardant and/or strengthened fiberboard, for example, a press board, an MDF board, and the like.

### Description of Related Art

For reducing the flammability of wood, it is known to treat the wood with a flame retardant. Usually, a corresponding flame retardant is applied to the surface of the wood. In order to achieve a good fire protection class, i.e., to reduce the flammability of the wood, correspondingly thick layers of flame retardant must be applied. This is expensive because of the considerable consumption of flame retardant. Further, this would limit the possibilities of designing the surface.

EP 0 255 950 A2 relates to a process in which hardboards are impregnated to obtain flame retardant boards. Thus, the boards are soaked with an aqueous salt solution and subjected to a pressure impregnation method. A uniform impregnation of the board is not ensured.

DE 103 14 974 A1 relates to a process for manufacturing molded parts. Thus, fibers are arranged in a premold and subsequently soaked with waterglass. A corresponding approach can adversely affect the strength of the board. The process cannot be applied selectively to individual boards, but only on the batch level within industrial production.

### DESCRIPTION OF THE INVENTION

It is an object of the invention to provide a fiberboard that has a low flammability.

The process according to the invention relates to the production of a flame retardant fiberboard, such as a press board, an MDF board, and the like. In a first step, a tailored fiberboard is charged on a processing device. Then, application of a flame retardant to a top side of the fiberboard is effected in the processing device. Subsequently, a pressure difference is generated between the top side and the bottom side of the fiberboard to suck the flame retardant into the fiberboard. For example, this can be done by applying a pressure generation device to the top side of the fiberboard. The pressure generation device may be, for example, a cuboid body that is open towards the board and connected with a corresponding source of compressed air. Alternatively, a corresponding suction device can be provided on the bottom side of the board, and it is also possible to combine a pressure device and a suction device.

The generation of the pressure difference causes suction of the flame retardant into the fiberboard. This results in a better protection of the wood and in a significant reduction of flammability. Thus, for the same fire protection class, the amount of necessary flame retardant is clearly reduced, or the fire protection class can be increased accordingly. In particular, this is because the flame retardant is provided not only on the surface of the fiberboard, with the consequence that the fire does not directly contact easily inflammable wood as soon as the flame retardant has burned or been consumed. The suction according to the invention has the effect that, even when upper layers of the fiberboard are destroyed or damaged, flame retardant provided within the board is still present. Thus, untreated wood of a fiberboard is not, or only later, exposed to the fire, depending on how deep the flame retardant is sucked into the fiberboard.

A particular advantage of the process is the fact that it can be applied to individual, normally produced boards.

Another particular advantage is the fact that the process can be applied selectively to selected areas of the board. Thus, for example, areas of a board that come into contact with metal during use can be provided with a particularly high content of flame retardant, while other areas have no or only a low content of flame retardant.

In particular, the process according to the invention allows for the boards to be individualized. According to the invention, boards of building material classes A1, A2 and B1 can be obtained. These may be derived from the same large-scale production, and subsequently be treated with different amounts of flame retardant.

Suitable flame retardants include both halogenated flame retardants and nitrogen-based or organophosphorus flame retardants, non-halogenated compounds being preferred. Particularly preferred compounds include ammonium polyphosphates, triaryl phosphates, trialkyl phosphates, melamine polyphosphates, and phosphinates.

Typical suitable compounds include TCEP (tris(chloroethyl) phosphate), TCPP (tris(chloropropyl) phosphate), TDCPP (tris(dichloroisopropyl) phosphate), TPP (triphenyl phosphate), TEHP (tris(2-ethylhexyl) phosphate), TKP (tricresyl phosphate), ITP (isopropylated triphenyl phosphate), mono-, bis- and tris(isopropylphenyl) phosphate, RDP (resorcinol bis(diphenylphosphate)), BDP (bisphenol-A-bis(diphenylphosphate)), and TBP (tributyl phosphate).

Preferably, these flame retardants have the effect that the heat causes the agent to foam. This results in the wood burning later, or only at higher temperatures. Because of the flame retardant being sucked into the fiberboard, the latter absorbs more flame retardant. Thus, the time during which the wood in question withstands the fire is significantly longer.

Preferably, the flame retardant is applied to both the top side and the bottom side and is thus sucked or pressed into the board from both sides. This can be done in subsequent steps, in which, for example, the same step is performed for generating the pressure difference, and the fiberboard is turned in the meantime.

Further, it is known that fiberboards may be strengthened. Thus, a strengthening agent is introduced into the fiberboard, so that the risk of swelling from moisture is reduced, in particular.

An agent that forms polyurethane (PUR), i.e., mixtures of dialcohols (diols) or polyols with di- or polyisocyanates, is preferably employed as the strengthening agent. Such mixtures are also employed as prepolymers, i.e., partially reacted monomers.

Therefore, in a particularly preferred embodiment, the introduction of a strengthening agent into the fiberboard is performed in addition to the introduction of a flame retardant. Here, the strengthening agent is also preferably sucked or pressed into the fiberboard. This is again achieved by generating an appropriate pressure difference. It is possible to introduce the two agents successively into the fiberboard. It is particularly preferred to introduce the flame retardant and the strengthening agent jointly into the fiberboard. In particular, the two agents are mixed together before being sucked or pressed into the fiberboard. Thus, a homogeneous distribution of the two agents can be realized.

The application of the flame retardant and optionally the strengthening agent to a top side and/or bottom side of a fiberboard is preferably effected by pouring , so that the material is uniformly distributed on the surface.

Alternatively, this may also be effected by application with a roll or tassel.

Preferably, from 20 to 200 g/m² of flame retardant is applied. Further, preferably from 200 to 1200 g/m², in some cases even from 200 to 1500 g/m², of strengthening agent is applied.

Preferred amounts, based on one cubic meter of fiberboard, are from 5 to 50 kg of flame retardant and from 50 to 500 kg of strengthening agent.

Preferably, the flame retardant and strengthening agent are applied together.

For an 8 mm thick board, the total amount possible should not be lower than 50 g/m², because small amounts are more difficult to distribute uniformly, especially because of inhomogeneities of the boards. Typically, the total amount of agent to be sucked in or pressed in should be within a range of from 50 to 250 g/m², or up to 500 g/m², and possibly not above 1 kg/m² for an 8 mm board.

An 8 mm board into which one kilogram of agent is sucked would increase its density by about 125 kg/m³. For typical fiberboards with densities within a range of about from 480 kg/m² to 980 kg/m², this is a noticeable weight gain.

Another independent invention that is combined with the present invention relating to the introduction of flame retardant in a preferred embodiment relates to the strengthening of fiberboards.

In this process, a tailored fiberboard to be strengthened is at first charged on a processing or strengthening device. Subsequently, strengthening agent is applied to the top side of the fiberboard, which is done by spraying, in particular.

An agent that forms polyurethane (PUR), i.e., mixtures of dialcohols (diols) or polyols with di- or polyisocyanates, is preferably employed as the strengthening agent. Such mixtures are also employed as prepolymers, i.e., partially reacted monomers.

The strengthening agent is sucked or pressed into the fiberboard by generating a pressure difference between the top side and bottom side of the fiberboard. The strengthening of the board is effected by the drying or reacting of the strengthening material. Upon being sucked in, the strengthening material employed reacts with the residual moisture present in the fiberboard.

According to the invention, a reaction accelerating agent is applied to the top side of the fiberboard before the strengthening agent is applied thereto. In the next step, either the strengthening agent may be applied directly, so that the strengthening agent is sucked in together with the reaction accelerating agent, or the reaction accelerating agent is sucked first into the fiberboard, then the strengthening agent is applied and subsequently sucked into the fiberboard. The use of reaction accelerating agent causes a faster reaction of the strengthening agent. Preferably, an agent that contains water is used as the reaction accelerating agent. In particular, the agent contains more than 90% water. The use of water as the reaction accelerating agent is particularly preferred. The application or optionally suction of the water or reaction accelerating agent to or into the fiberboard results in an increase of the moisture content within the board. This results in an improved reaction of the strengthening agent within the board and thus in a better and faster strengthening of the board.

Preferably, from 3 to 5 g/m³ of reaction accelerating agent, especially water, per m³ of fiberboard is applied. Preferably, the reaction accelerating agent is applied by rolling.

In order to enable further processing or storage of the strengthened fiberboard as quickly as possible, it is further preferred to subsequently dry it.

The reaction between the strengthening agent and the reaction accelerating agent generates heat. Therefore, there is a risk of self-ignition of the fiberboard. This risk can be counteracted by a corresponding aeration or cooling of the board.

Therefore, in a particularly preferred further embodiment according to the invention, a combination of the introduction of a reaction accelerating agent and a flame retardant is effected. By using the flame retardant, the risk of self-ignition because of the reaction temperature is significantly reduced, or completely avoided, in particular. Thus, the combination of the two inventions described above, which relate to the introducing of flame retardant on the one hand and the introducing of reaction accelerating agent on the other, is particularly preferred, preferably in the embodiments described.

All quoted documents are included herein by reference to the full extent thereof, unless the disclosure contained therein is in contradiction to the teaching of the invention.

1. A process for producing a flame retardant fiberboard, comprising the steps of:
charging a tailored fiberboard on a processing device;
applying a flame retardant to a top side of the fiberboard, and
generating a pressure difference between the top side and the bottom side of the fiberboard to suck or press the flame retardant into the fiberboard.

2. The process according to claim 1, wherein said flame retardant is applied together with a strengthening agent.

3. The process according to claim 2, wherein said flame retardant and said strengthening agent are applied jointly.

4. The process according to claim 1, wherein from 5 to 50 kg of flame retardant is applied per m³ of the fiberboard.

5. The process according to claim 2, wherein from 50 to 500 kg of strengthening agent is applied per m³ of the fiberboard.

6. The process according to claim 2, wherein said strengthening agent or said flame retardant is applied by spraying.

7. The process according to claim 2, wherein a reaction accelerating agent is applied to the top side of the fiberboard before the strengthening agent is applied thereto.

8. The process according to claim 7, wherein said reaction accelerating agent comprises water.

9. The process according to claim 8, wherein said reaction accelerating agent comprises more than 90% by weight of water.

10. The process according to claim 7, wherein from 3 to 5 grams of reaction accelerating agent is applied per m³ of the fiberboard.

11. The process according to claim 7, wherein said reaction accelerating agent is applied to the top side of the fiberboard by rolling.

12. The process according to claim 1, wherein said fiberboard has at least two areas that comprise different amounts of flame retardant per volume.

13. The process according to claim 1, wherein said fiberboard is dried in a drying device after said flame retardant is sucked or pressed in.

14. The process according to claim 2, wherein said fiberboard is dried in a drying device after said strengthening agent and said flame retardant are sucked or pressed in.

15. A process for the production of a strengthened fiberboard, comprising the steps of:
charging a tailored fiberboard on a processing device;
applying a strengthening agent to a top side of the fiberboard, and
generating a pressure difference between the top side and a bottom side of the fiberboard to suck or press the strengthening agent into the fiberboard;
wherein a reaction accelerating agent is applied to the top side of the fiberboard before the strengthening agent is applied thereto.

16. The process according to claim 15, wherein said reaction accelerating agent comprises water.

17. The process according to claim 16, wherein said reaction accelerating agent comprises more than 90% by weight of water.

18. The process according to claim 15, wherein said from 3 to 5 grams of reaction accelerating agent is applied per m³ of the fiberboard.

19. The process according to claim 15, wherein said reaction accelerating agent is applied to the top side of the fiberboard by rolling.
